(19) United States
(12) Patent Application Publication
(10) Pub. No.: US 2010/0137131 A1
(43) Pub. Date: Jun. 3, 2010

(54) PHOTOCATALYST STRUCTURE

(75) Inventors: Koichi Awazu, Tsukuba-shi (JP); Hirotaka Murakami, Tsukuba-shi (JP); Toshiya Watanabe, Fujisawa-shi (JP); Naoya Yoshida, Ashigarakami-gun (JP)

Correspondence Address: VENABLE LLP, P.O. BOX 34385, WASHINGTON, DC, 20043-9998, US

(73) Assignee: National Institute of Advanced Industrial Science and Technology, Tokyo (JP)

(21) Appl. No.: 12/596,297

(22) PCT Filed: Apr. 9, 2008
(86) PCT No.: PCT/JP2008/056999

§ 371 Date: Nov. 25, 2009

(30) Foreign Application Priority Data
Apr. 16, 2007 (JP) 2007-107381

(51) Int. Cl. B01J 21/08; B01J 23/00; B01J 23/50; B01J 21/06

(52) U.S. Cl. 502/240; 502/300; 502/347; 502/350; 977/773

(57) ABSTRACT

The present invention provides a photocatalyst structure capable of improving catalyst efficiency dramatically and stably. In the present invention, the photocatalyst structure is comprised of a metal nanoparticle, a semiconductor photocatalyst, and a material intervening between the metal nanoparticle and the semiconductor photocatalyst. The material is transparent to a light of a wavelength which excites the semiconductor photocatalyst.

### TECHNICAL FIELD

The present invention relates to a photocatalyst structure with excellent catalyst efficiency.

### BACKGROUND ART

The photocatalyst is a catalyst that, when being irradiated by a light of a wavelength having an energy equal to or more than its own band gap, generates electrons in its conduction band and holes in its valence band by photoexcitation thereby decomposing a detrimental material etc. by their strong reducing power or oxidizability. Paying attention to various functions of photocatalyst, such as air purification, water purification, antibacterial property and sterilization, and antifouling and defogging, applications of photocatalyst in respective industrial fields are being considered variously.

A technology of bringing metal particles into contact with the surface of titanium oxide that is the photocatalyst for the purpose of improving a quantum yield as a catalyst (catalyst efficiency) is known (for example, refer to Non-patent Document 1). A reason that this technology improves the quantum yield (catalyst efficiency) is thought that by bringing the metal particle into contact with the surface of titanium oxide, the reactions of both oxidation and reduction occur at separate places, which can prevent deactivation by recombination of electrons and holes.

Moreover, as the photocatalyst capable of raising use efficiency of light, a technology of making the photocatalyst material and a metallic material for causing surface plasmon resonance coexist (for example, refer to Patent Document 1) is known.
Patent Document 1: Japanese Patent Laid-Open No. 2005-288405.
Non-patent Document 1: Kazuhito Hashimoto and Akira Fujishima ed., “All of titanium oxide photocatalyst for antibacterial effect, antifouling, and air purification,” CMC Publishing Co., Ltd., July 1998, p. 22.

### DISCLOSURE OF THE INVENTION

### Problems to be Solved by the Invention

However, in the technologies of bringing the metal particles into contact with the surface of titanium oxide described above, a catalyst efficiency improvement effect is about two times, and further improvement in catalyst efficiency is desired.

Moreover, in the above technology of making a photocatalyst material and the metallic material for causing surface plasmon resonance coexist, the surface plasmon resonance may disappear depending on the state of the metallic material.

Therefore, the catalyst efficiency cannot necessarily be improved stably only by making the photocatalyst material and the metallic material coexist.

The present invention addresses the above, and its object is to provide a photocatalyst structure capable of improving the catalyst efficiency dramatically and stably.

### Means for Solving the Problem

The inventors of the present invention obtained a finding that the above-mentioned problems can be solved by concretely specifying a mode in which a metal nanoparticle and a semiconductor photocatalyst are made to coexist, and has completed the present invention based on such finding.

That is to say, the concrete means for solving the problem is as follows.

<1> The means is the photocatalyst structure, comprising: a metal nanoparticles; a semiconductor photocatalyst; and a material that intervenes between the metal nanoparticles and the semiconductor photocatalyst, the material being transparent to a light of a wavelength which excites the semiconductor photocatalyst.
<2> The means is the photocatalyst structure according to <1>, wherein the metal nanoparticles do not exist on a reaction surface of the semiconductor photocatalyst.
<3> The means is the photocatalyst structure according to <1> or <2>, wherein the semiconductor photocatalyst is a thin film formed on a base material.
<4> The means is the photocatalyst structure according to any one of <1> to <3>, wherein the material transparent to the light of the wavelength which excites the semiconductor photocatalyst is a thin film formed on the base material so as to cover at least part of the metal nanoparticles, and wherein the semiconductor photocatalyst is a thin film formed on the thin film comprised of the transparent material.
<5> The means is the photocatalyst structure according to any one of <1> to <4>, wherein the metal nanoparticles include silver.
<6> The means is the photocatalyst structure according to any one of <1> to <5>, wherein the semiconductor photocatalyst includes titanium oxide.
<7> The means is the photocatalyst structure according to any one of <1> to <6>, wherein the material transparent to the light of the wavelength which excites the semiconductor photocatalyst includes silicon oxide.

### EFFECTS OF THE INVENTION

According to the present invention, the photocatalyst structure capable of improving the catalyst efficiency dramatically and stably can be obtained.

### BRIEF DESCRIPTION OF THE DRAWINGS

FIG. 1A is a sectional view schematically showing a first embodiment of the present invention.

FIG. 1B is a sectional view schematically showing a first embodiment of the present invention.

FIG. 2 is a sectional view schematically showing a second embodiment of the present invention.

FIG. 3 is a diagram showing an electric field strength of localized surface plasmon light.

FIG. 4 is a diagram showing a relation between the localized surface plasmon light of the silver nanoparticles of 50 nm in radius and an amorphous silica film thickness in the present invention.

FIG. 5 is a diagram showing a relation between the localized surface plasmon light of the silver nanoparticles of 50 nm in radius and the amorphous silica film thickness in the present invention.

FIG. 6 is optical absorption spectra of the silver nanoparticles under different formation conditions.

FIG. 7 is a diagram showing the electric field strengths outside the silver nanoparticle and outside amorphous silica.

FIG. 8A is an SEM image of the silver nanoparticles formed using a sputtering technique.

FIG. 8B is an SEM image of the silver nanoparticles formed using vacuum deposition.

FIG. 9A is an SEM image after the formation of amorphous silica in the case of forming the silver thin film with a film thickness of 3.0 nm.

FIG. 9B is an SEM image after the formation of amorphous silica in the case of forming the silver thin film with a film thickness of 7.0 nm.

FIG. 10A is an SEM image after the formation of amorphous silica in the case of forming the silver thin film with a film thickness of 0.9 nm.

FIG. 10B is an SEM image after the formation of amorphous silica in the case of forming the silver thin film with a film thickness of 12.0 nm.

FIG. 11A is an SEM image showing a cross section of one mode of the present invention.

FIG. 11B is an SEM image showing a titanium oxide film surface of one mode of the present invention.

FIG. 12 is optical absorption spectra in the one mode of the present invention and the comparison samples.

FIG. 13A is a graph showing catalyst efficiency in one mode of the present invention.

FIG. 13B is a graph showing catalyst efficiency in the comparison sample.

FIG. 14 is an optical absorption spectrum that indicates the dependence of the localized surface plasmon light on the amorphous silica film thickness for one mode of the present invention.

FIG. 15 is the optical absorption spectrum that indicates the dependence of the localized surface plasmon light on the amorphous silica film formation conditions etc. for one mode of the present invention.

### EXPLANATION OF REFERENCE

10 Base material
12 Metal nanoparticle
14 Material (transparent material) transparent to light of wavelength which excites semiconductor photocatalyst
16 Semiconductor photocatalyst
20 Circle representing a surface of a silver nanoparticle
22 Circle representing a surface of a amorphous silica
30 Electric field strength around silver nanoparticle (Inner shell)
32 Electric field strength around amorphous silica (Outer shell)
50 Amorphous silica substrate
52 Silver nanoparticle
54 Amorphous silica film
56 Titanium oxide film
58 Cloud-like white area (silver nanoparticles covered with titanium oxide film and amorphous silica film)

### BEST MODE FOR CARRYING OUT THE INVENTION

A photocatalyst structure of the present invention is comprised of a metal nanoparticle, a semiconductor photocatalyst, a material transparent to a light of a wavelength which excites the above-mentioned semiconductor photocatalyst intervening between the metal nanoparticle and the semiconductor photocatalyst.

By making the metal nanoparticles and the semiconductor photocatalyst coexist, use efficiency of light in the semiconductor photocatalyst can be improved dramatically by the localized surface plasmon light of the metal nanoparticles. However, the localized surface plasmon light disappears when the metal nanoparticle oxidizes. Hence, by placing a material transparent to a light of a wavelength which excites the semiconductor photocatalyst between the metal nanoparticles and the semiconductor photocatalyst, it is possible to prevent oxidation of the metal nanoparticle and maintain the localized surface plasmon light. Therefore, by adopting the above-mentioned configuration, the photocatalyst structure of the present invention can improve catalyst efficiency of the semiconductor photocatalyst dramatically and stably.

Since in the case where the transparent material is not placed between, the metal nanoparticles oxidize easily, and will not generate the localized surface plasmon light, the catalyst efficiency cannot be improved stably.

In the photocatalyst structure of the present invention, it is desirable for the metal nanoparticles not to exist in the react ion surface of the semiconductor photocatalyst. That is to say, it is desirable for the metal nanoparticles to be contained in the semiconductor photocatalyst. By configuring the semiconductor photocatalyst in this way, a part of the reaction surface of the semiconductor photocatalyst is not interrupted by the metal nanoparticles, so that the use efficiency of light improves further and the catalyst efficiency improves further.

Although there is no restriction in particular as a mode of the photocatalyst structure of the present invention, the following two embodiments are suitable. Incidentally, in the following, the “material transparent to the light of the wavelength which excites the semiconductor photocatalyst” may be simply referred to as the “transparent material.”

The first embodiment of the photocatalyst structure of the present invention is a mode in which a thin film comprised of a semiconductor photocatalyst is provided on a base material, metal nanoparticles are contained in the thin film, and the transparent material is made to exist at a part or the whole of the interface between the metal nanoparticles and the thin film. Among the first embodiments, a mode such that the transparent material is a thin film formed on the base material so as to cover at least part of the metal nanoparticles, and the semiconductor photocatalyst is a thin film formed on the thin film comprised of the transparent material.

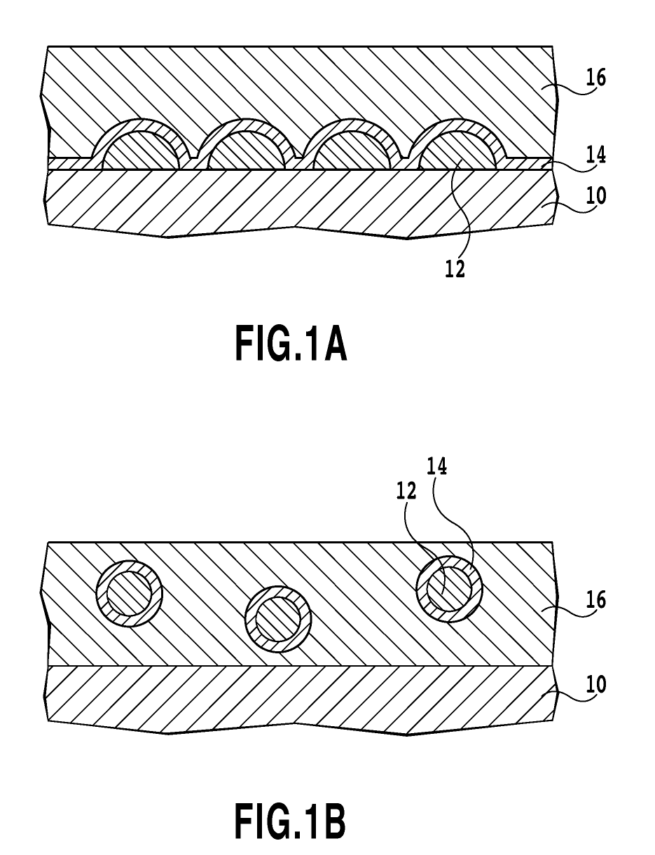

FIGS. 1A, 1B are both sectional views schematically showing the first embodiment.

In FIG. 1A, metal nanoparticles 12 exist on a base material 10, a transparent material 14 is formed on the base material so as to cover the metal nanoparticles 12, and the photocatalyst is formed on the transparent material 14. Incidentally, in order to make the structure easy to understand, FIGS. 1A, 1B represent the metal nanoparticles 12 in hemispheres, and represents the transparent material 14 as a thin film with uniform film thickness. However, neither the shape of the metal nanoparticles nor the shape of the transparent material in the first embodiment are necessarily limited to the shape of the metal nanoparticles or the shape of the transparent material shown in FIGS. 1A, 1B.

In FIG. 1B, a semiconductor photocatalyst 16 is formed on the base material 10, and the metal nanoparticles 12 covered with the transparent materials 14 are included therein.

From a viewpoint of obtaining an effect of the present invention more effectively, it is desirable for the first embodiment to fulfill the following conditions.

That is to say, regarding the film thickness of the semiconductor photocatalyst, 10 to 1000 nm is desirable, and 50 to 150 nm is more desirable. Regarding the film thickness of the transparent material (thickness on the base material), 100 nm or less is desirable, and 5 to 50 nm is more desirable. Regarding the thickness of the transparent material (thickness on the metal nanoparticles), 2 to 50 nm is desirable, and 2 to 9 nm is more desirable. Regarding the particle size of the metal nanoparticles, 5 to 100 nm is desirable, and 10 to 100 nm is more desirable.

Moreover, for the base material 10, various materials, such as metals, plastics, ceramics, semiconductors, crystals, and timbers, can be used without special restriction.

A second embodiment of the photocatalyst structure of the present invention is a mode in which particle-like semiconductor photocatalyst contains a metal nanoparticle whose part or whole is covered with a transparent material.

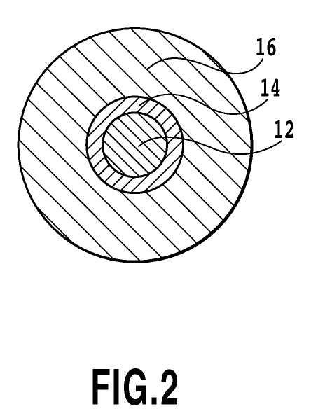

FIG. 2 is a sectional view schematically showing the second embodiment.

In FIG. 2, the metal nanoparticle 12 covered with the transparent material 14 is contained in the particle-like semiconductor photocatalyst 16.

From a viewpoint of obtaining the effect by the present invention more effectively, it is desirable for the second embodiment to fulfill the following conditions.

Regarding the particle size of the semiconductor photocatalyst, 20 to 2000 nm is desirable, and 100 to 300 nm is more desirable. Regarding the thickness of the transparent material on the metal nanoparticle, 200 nm or less is desirable, and 20 to 100 nm is more desirable. Regarding the number average particle size of the metal nanoparticles, 5 to 300 nm is desirable, and 5 to 100 nm is more desirable.

Next, each component constituting the photocatalyst structure will be explained.

### <Metal Nanoparticle>

The photocatalyst structure of the present invention contains at least one kind of metal nanoparticle.

Although there is no restriction in particular as the metal nanoparticle, from a viewpoint of using the localized surface plasmon light more effectively, it is desirable for the metal nanoparticle to include silver, gold, copper, or aluminum, or any kind of alloy that includes these, and it is more desirable to include silver. Here, the metal nanoparticle that includes silver may be either the silver nanoparticle consisting of only silver atoms or a sliver alloy nanoparticle comprised of silver atoms and other metal atoms.

<Semiconductor Photocatalyst>

The photocatalyst structure of the present invention contains at least one kind of semiconductor photocatalyst.

Although there is no restriction in particular as the semiconductor photocatalyst, titanium oxide, nitrogen doped titanium oxide, carbon doped titanium oxide, and sulfur doped titanium oxide can be used. From a viewpoint of improvement in catalyst efficiency, titanium oxide is desirable among them.

From a viewpoint of efficient use of the localized surface plasmon light, it is desirable that a combination of the metal nanoparticle and the semiconductor photocatalyst is selected so that the wavelength of the localized surface plasmon light of the metal nanoparticle and the wavelength of the light which excites the semiconductor photocatalyst are close to each other (desirably, so that the overlap of the absorption bands becomes equal to or more than 50%.)

From the above-mentioned viewpoint, desirable combinations in the present invention include the combination of a silver nanoparticle and a semiconductor photocatalyst (for example, titanium oxide), the combination of a platinum or gold nanoparticle and a nitrogen doped titanium oxide, the combination of a platinum or gold nanoparticle and a sulfur doped titanium oxide, etc.

The combination of a silver nanoparticle and a titanium oxide is especially desirable among them.

Incidentally, the wavelength of the light which excites titanium oxide is approximately 380 nm. On the other hand, the wavelengths of the localized surface plasmon light of the silver nanoparticle are in the vicinity of 350 to 410 nm in the case of the silver nanoparticle of 20 nm in radius, and 350 to 550 nm in the case of the silver nanoparticle of 50 nm in radius.

<Material Transparent to Light of Wavelength Which Excites Semiconductor Photocatalyst>

The photocatalyst structure of the present invention contains at least one kind of material transparent to the light of the wavelength which excites the semiconductor photocatalyst (hereinafter also referred to as “transparent material”).

Here, “transparent” means that the transmittance of the light of the wavelength which excites the semiconductor photocatalyst is equal to or more than 10%.

From a viewpoint of the use efficiency of light, a transmittance of 90% or more is more desirable.

As the transparent material, although there is no restriction in particular, silica (amorphous silica etc.), well-known plastic materials, and well-known glass materials can be used.

From viewpoints of the use efficiency of light and of anti-oxidation of the metal nanoparticles, amorphous silica is desirable among them.

<Manufacture Method of Photocatalyst Structure>

Although there is no restriction in particular about the manufacture method of the photocatalyst structure of the present invention, the photocatalyst structure in the first embodiment can be manufactured in the following way, for example.

That is to say, the photocatalyst structure can be manufactured by forming metal nanoparticles on a base material, forming the transparent material described above on a surface of the base material on which the silver nanoparticles are formed, and forming the semiconductor photocatalyst on the formed transparent material.

The metal nanoparticles can be formed by forming a metal thin film and then heat treating the formed metal thin film. Such a formation method of the metal nanoparticles is described, for example, in T. Shima and J. Tominaga, J.Vac.Sci. and Technol., A21, 634 (2003).

Formation of the metal thin film can be done by well-known methods, such as vacuum deposition and sputtering techniques. Among them, the vacuum deposition is desirable from a viewpoint of making the metal nanoparticles uniform in size.

As conditions for the vacuum deposition, although they depend on the kind of metal, a degree of vacuum of 3×10⁻⁴ or less and an energizing heating electric current of 50 to 100 A are desirable.

Although conditions of the heat treatment depend on the kind of metal, it is desirable to perform heat treatment at 200-1000° C. for 1 to 100 minutes, and more desirably at 700-800° C. for 5 to 10 minutes.

Although formation of the transparent material depends on the kinds of transparent materials, it can be performed by well-known methods, such as sputtering techniques, vacuum deposition, sol gel methods, and liquid phase deposition. Among them, the sputtering technique is desirable from viewpoints of anti-oxidation of the metal nanoparticle etc.

As conditions for the sputtering technique, a sputtering electric power of 40-300 W is desirable, and 50-200 W is more desirable from the viewpoints of anti-oxidation of the metal nanoparticle etc.

Formation of the semiconductor photocatalyst can be attained by known methods, such as sputtering techniques, vacuum deposition, sol gel methods, and liquid phase deposition methods, although it depends upon the kind of semiconductor photocatalyst.

As a method for forming the particle-like semiconductor photocatalyst, a sol gel method and other chemical techniques are desirable.

<Localized surface Plasmon Light, Use Efficiency of Light, Etc.>

Next, as a matter relevant to the effects of the present invention, the localized surface plasmon light, the use efficiency of light, etc. will be explained by taking a case where silver nanoparticles are used as metal nanoparticles, titanium oxide is used as semiconductor photocatalyst, and amorphous silica is used as transparent material as an example.

(Calculation Result of Electric Field Strength of Localized Surface Plasmon Light)

For a structure 1 where silver particle of 20 mm in radius is coated with amorphous silica (SiO₂) with a thickness of 10 nm on its periphery, an electric field intensity of the localized surface plasmon light generated from the structure 1 was calculated by the Mie scattering theory.

Incidentally, Mie scattering is explained, for example, in Iwanami Physics and Chemistry Encyclopedia (fifth edition), p. 1351 in detail.

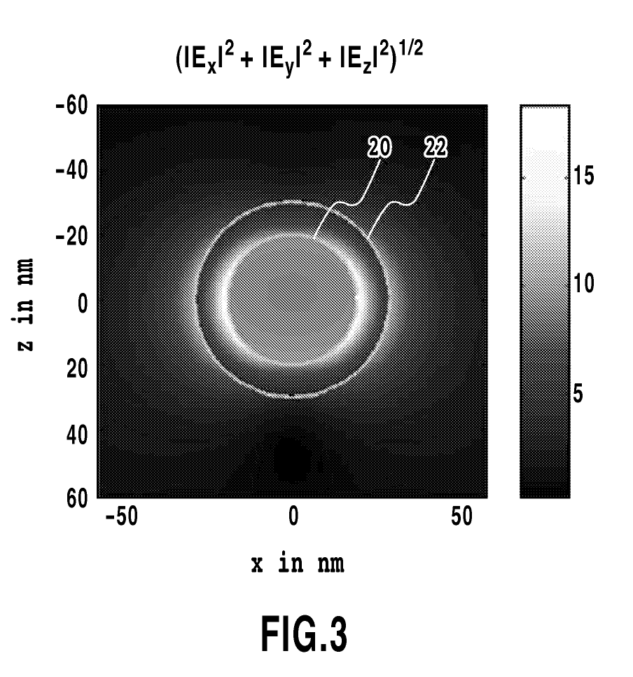

FIG. 3 is a diagram showing the electric field strength of the localized surface plasmon calculated as above (calculation result).

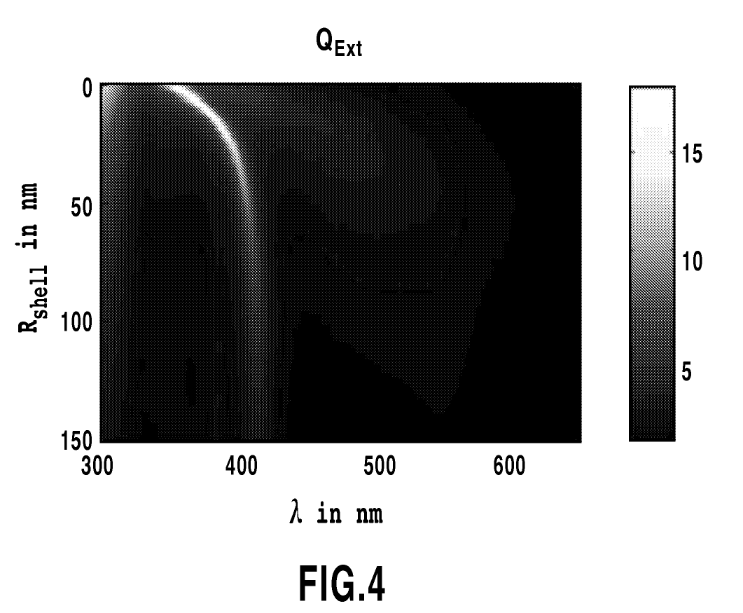

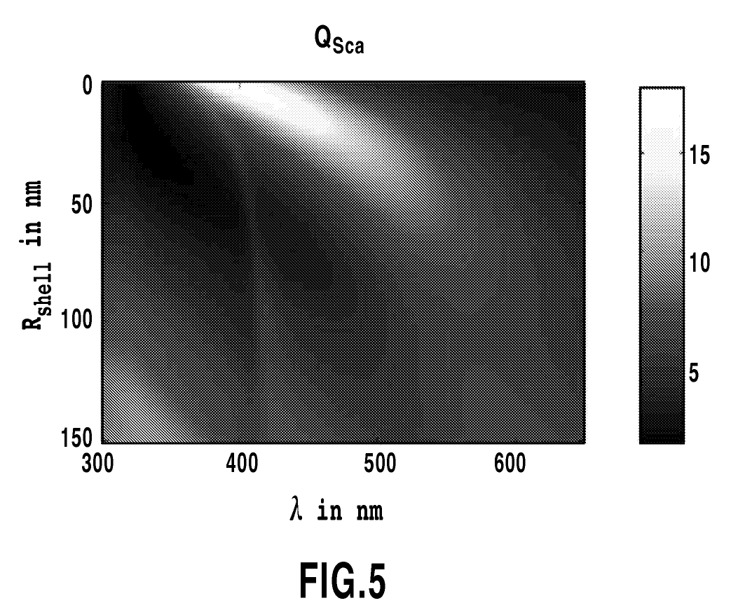

An inside circle 20 in FIG. 3 represents a silver nanoparticle surface of 20 nm in radius, and an outside circle 22 represents an amorphous silica surface with a thickness of 10 nm. Thinner color shows stronger electric field strength (this is so also in FIG. 4 and FIG. 5).

FIG. 3 indicates that the localized surface plasmon light is generated not only near the silver nanoparticle surface but also near the amorphous silica surface.

The above calculation result indicates that even when the transparent material is placed between the metal nanoparticle and the semiconductor photocatalyst, the localized surface plasmon light can be utilized.

Note that, in the actual experiment, the localized surface plasmon light was not observed in the case where the transparent material was not placed between the metal nanoparticle and the semiconductor photocatalyst, and the localized surface plasmon light was observed only in the case where the transparent material was placed between the metal nanoparticle and the semiconductor photocatalyst (refer to the second example described later). The cause of this is considered to lie in a fact that, in the case of the former, the metal nanoparticles are oxidized and do not have localized surface plasmon light.

(Dependence of Localized Surface Plasmon Light on Amorphous Silica Film Thickness)

FIG. 4 shows a change of the wavelength λ of the localized surface plasmon light and a change of the electric field strength (calculation results) when the film thickness of amorphous silica is varied in the above-mentioned structure 1.

FIG. 4 indicates that the thinner the thickness of amorphous silica, the stronger the electric field strength becomes and the shorter the wavelength becomes. Moreover, FIG. 4 indicates that when the thickness of amorphous silica is thickened, the wavelength of the localized surface plasmon light converges in the vicinity of 410 nm. When considering a known fact that catalyst activity of titanium oxide becomes high at wavelengths of 400 nm and shorter, it is desirable that the thickness of amorphous silica, which is a coating film of the silver nanoparticles, is equal to or less than 50 nm for example in the configuration of the structure 1.

(Dependence of Localized Surface Plasmon Light on Silver Nanoparticle size)

FIG. 5 shows a change of a wavelength λ of the localized surface plasmon light and a change of an electric field strength when the film thickness of the amorphous silica is varied (calculation results) for a structure 2 where the radius of the silver nanoparticles of the above-mentioned structure 1 is changed from 20 nm to 50 nm.

FIG. 5 indicates that in the case where the silver nanoparticle is 50 nm in radius, the wavelength of the localized surface plasmon light becomes a wide band as compared with a case of 20 nm radius. The wavelength even reaches to an area of 500 nm and higher.

As shown in the above calculation results, adjustment of the radius of the metal nanoparticles enables the wavelength of the localized surface plasmon light of the metal nanoparticles to be tuned to the excitation wavelength of the semiconductor photocatalyst that is used together. For example, in the case of a combination of a silver nanoparticle and a photocatalyst having the excitation wavelength in the visible region, it can be seen that 50 nm is more suitable than 20 nm as the radius of the sliver nanoparticles. Moreover, it can be seen that in the case of a combination of a silver nanoparticle and a titanium oxide having the excitation wavelength at approximately 380 nm, 20 nm is more suitable than 50 nm as the radius of the silver nanoparticles.

(Dependence of Localized Surface Plasmon Light on Silver Nanoparticle Formation Conditions)

Next, silver nanoparticles were actually formed as follows, and the dependence of the localized surface plasmon light on the silver nanoparticle formation conditions was investigated.

By the vacuum deposition, silver thin films with film thicknesses of 2.5 nm, 3.0 nm, 5.0 nm, 7.0 nm, 9.0 nm, 10.0 nm, 12.0 nm, and 15.0 nm were formed on a substrate, respectively. Each substrate with the silver thin film was baked at 800° C. for five minutes to form silver nanoparticles thereon.

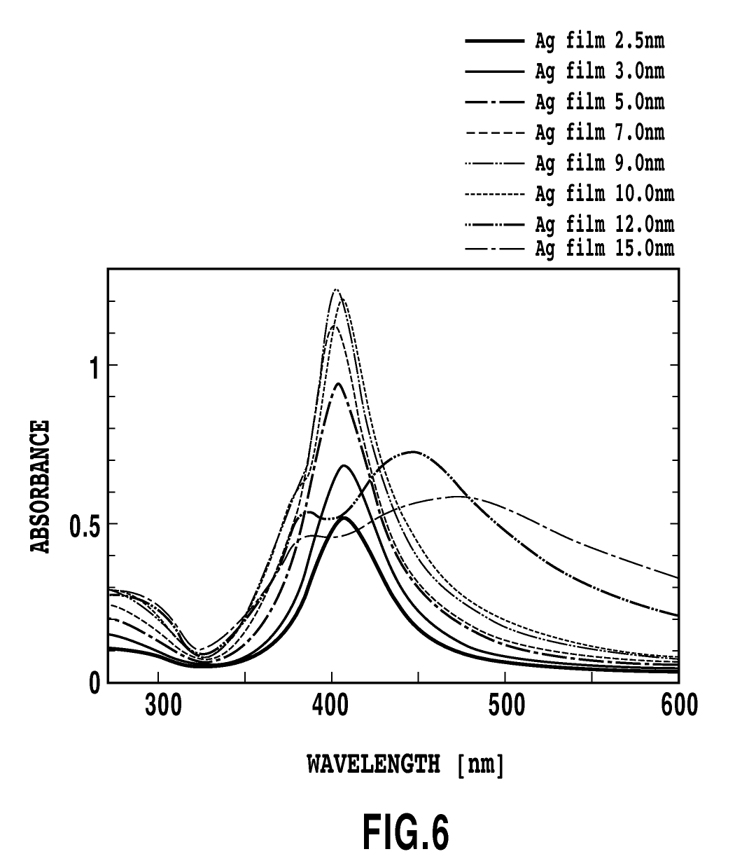

An optical absorption spectrum was measured for each of the silver nanoparticles formed under the condition of the each film thickness. FIG. 6 shows the result of the measurement.

It turned out that as the silver film thickness becomes thicker from 2.5 nm to 9.0 nm, the peak intensity of the localized surface plasmon light increases and shifts to a shorter wavelength side. It turned out that when it becomes larger than 10.0 nm, the peak intensity decreases and shifts to a longer wavelength side.

The above results have revealed that in the case of the combination of silver nanoparticles and titanium oxide having the excitation wavelength at approximately 380 nm, it is desirable to form the silver nanoparticles using silver thin films with film thickness of 10.0 nm or less.

(Calculation of Catalyst Efficiency)

The intensity of the localized surface plasmon light (wavelength of 394 nm) in directions of 360° around the silver nanoparticle was calculated for the structure 1 where the surroundings of the silver nanoparticle of 20 nm in radius is coated with amorphous silica (SiO₂) with a thickness of 10 nm.

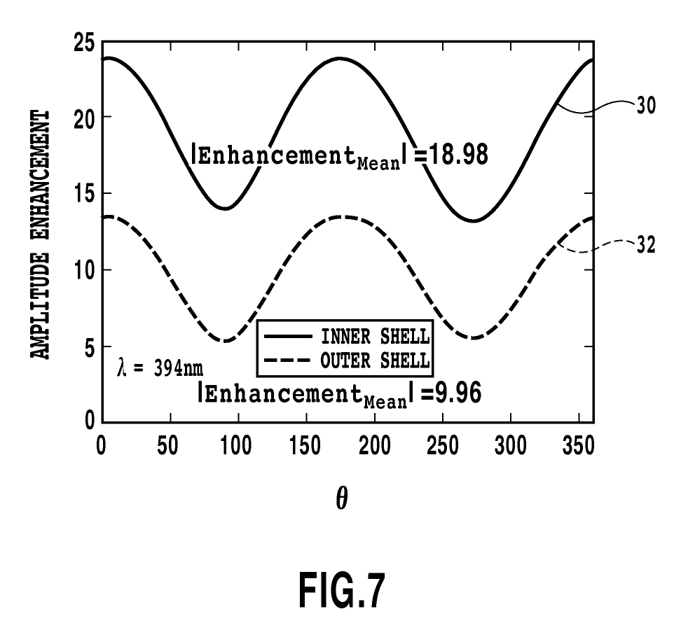

The graph of FIG. 7 shows calculation results of the electric field strength 30 around the silver nanoparticle (Inner shell) and of the electric field strength 32 around amorphous silica (Outer shell). The horizontal axis represents a position (θ) and the vertical axis represents a relative electric field strength (Amplitude enhancement) of the localized surface plasmon light when the electric field strength of incident light is set to unity.

FIG. 7 indicates that the electric field strength is increased by about 14 times at the maximum, and by about 10 times on the average around amorphous silica. Also, it indicates that the electric field strength is increased by about 24 times at the maximum, and by about 19 times on the average around the silver nanoparticle.

The above results have revealed that by encapsulating the structure 1 where silver nanoparticle of 20 nm in radius is coated with amorphous silica (SiO₂) with thickness of 10 nm around their peripheries in a semiconductor catalyst, the use efficiency of light becomes about 14 times larger at the maximum and about 10 times larger on the average, so that the catalyst efficiency becomes about 14 times larger at the maximum and about 10 times on the average compared with a case where a photocatalyst does not encapsulate the silver nanoparticle.

As described above, the photocatalyst structure of the present invention can improve the catalyst efficiency of the photocatalyst dramatically and stably. Therefore, the photocatalyst structure of the present invention is applicable to various industrial fields, such as housing-related, water treatment and soil-related, air treatment-related, medical care-related, electronic parts-related, electric appliance-related, vehicle-related, road-related, and agriculture-related fields.

### EXAMPLES

Hereafter, the present invention will be described more concretely by way of examples, but this invention shall not be limited to these examples.

### First Example

### Fabrication of Photocatalyst Structure

### (Formation of Silver Nanoparticles)

First, a silver thin film was formed on an amorphous silica substrate by the sputtering technique. Separately, a silver thin film was formed on an amorphous silica substrate by the vacuum deposition. The film thicknesses of the both of the silver thin films were set to 2.5 nm. Each of the amorphous silica substrates with the silver thin films formed thereon is treated by heat treatment (baking) at 700° C. for five minutes using a portable electric furnace F-B1414 type (a product of Barnstead International Corp.). On each of the amorphous silica substrates after the heat treatment, scanning electron microscope (SEM) observation was performed from the side on which silver thin film was formed. The result indicates that the silver nanoparticles can be formed by either of the sputtering technique or the vacuum deposition.

Detailed conditions of the sputtering technique and the vacuum deposition are as follows.

### —Silver Thin Film Formation Conditions by Sputtering Technique—

As a sputtering apparatus, the CFS-4EP-LL, a product of SHIBAURA MECHATRONICS CORP., was used. Formation of the silver thin film was done in an argon gas atmosphere under conditions of an output power of 50 Wand a degree of vacuum of 0.5 Pa using silver as a target.

### —Silver Thin Film Formation Conditions by Vacuum Deposition—

As a vacuum deposition apparatus, the Beamtron, a product of R-DEC Co., Ltd., was used. Formation of the silver thin film was done under conditions of a degree of vacuum of 3×10⁻⁴ Pa and an energizing heating electric current of 65 A.

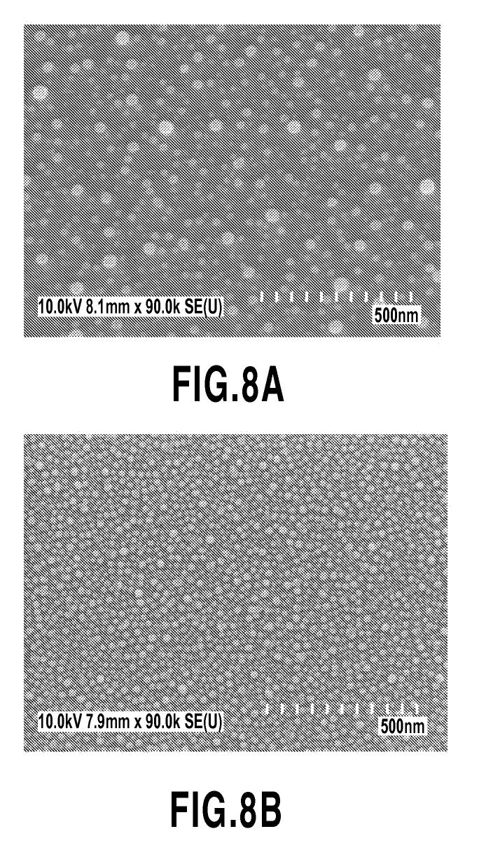

FIG. 8A is an SEM image showing a state where the silver nanoparticles were formed on the amorphous silica substrate using the sputtering technique; FIG. 8B is an SEM image showing a state where the silver nanoparticles were formed on the amorphous silica substrate using the vacuum deposition. A comparison of FIG. 8A and FIG. 8B indicates that the deposition method (FIG. 8B) can make the silver nanoparticles uniform in particle size, as compared with the sputtering technique (FIG. 8A) (in the case of the deposition method, the particle size is approximately 10 to 20 nm), so that the surface density of the silver nanoparticles can be raised.

(Formation of Amorphous Silica Film)

Under the same conditions as the conditions of the deposition method for forming the silver nanoparticles, silver thin films with the thicknesses of 3.0 nm, 7.0 nm, 9.0 nm, and 12.0 nm are formed on amorphous silica substrates (hereinafter also simply referred to as “substrate”) by the deposition method. Each of the four kinds of the substrates with the silver thin films is heat treated at 800° C. for 5 minutes, and the side on which silver thin film was formed of each substrate after the heat treatment is coated with an amorphous silica film with film thickness of 40 nm by the sputtering technique under the following conditions.

—Formation Conditions of Amorphous Silica Film by Sputtering Technique—

As a sputtering apparatus, the CFST4EP-LL, a product of SHIBAURA MECHATRONICS CORP., was used.

Formation of the amorphous silica film is performed under conditions of an output of 50 W and a degree of vacuum of 0.5 Pa in an argon gas atmosphere using SiO₂ as a target. When the sputtering was performed for 10 minutes, 15 minutes, and 20 minutes, the thicknesses of SiO₂ (amorphous silica film) became 20 nm, 30 nm, and 40 nm, respectively.

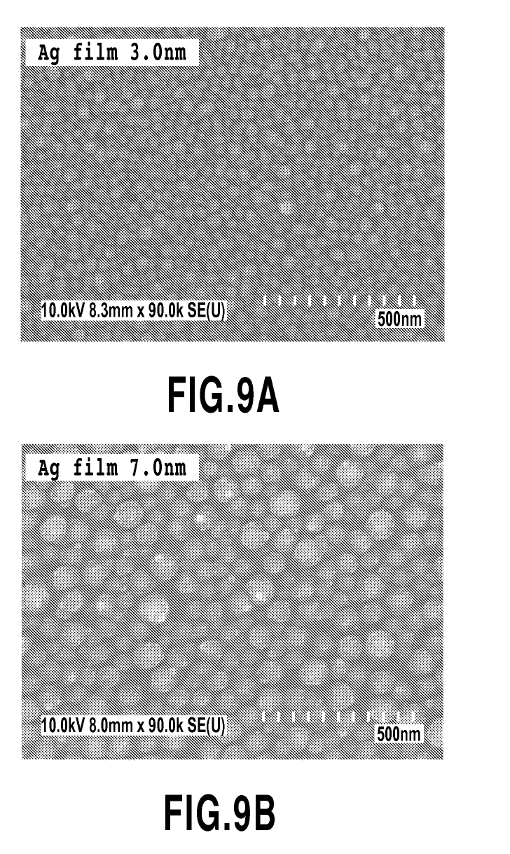

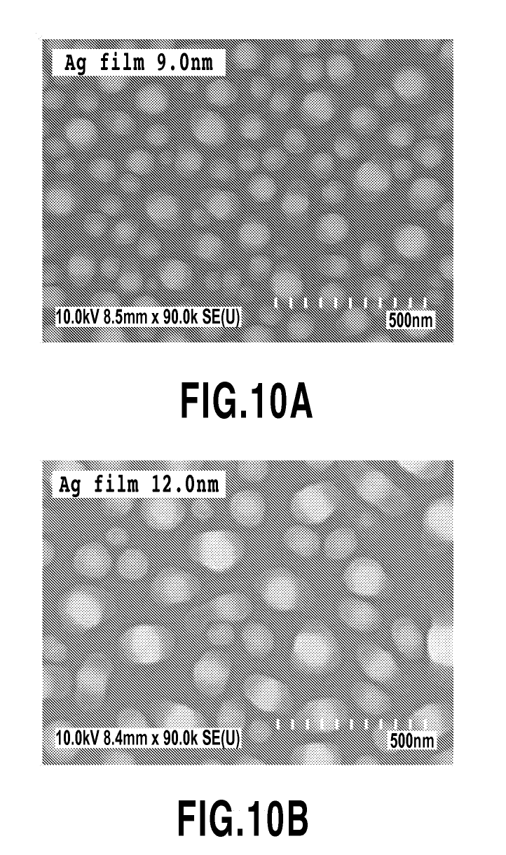

Observation with a scanning electron microscope (SEM) was performed on the each substrate coated with the amorphous silica film from the side on which the amorphous silica film was formed. FIG. 9A is an SEM image in the case of forming a silver thin film with film thickness of 3.0 nm; FIG. 9B is an SEM image in the case of forming a silver thin film with film thickness of 7.0 nm. FIG. 10A is an SEM image in the case of forming a silver thin film of film thickness of 9.0 nm; FIG. 10B is an SEM image in the case of forming a silver thin film with film thickness of 12.0 nm.

As shown in FIG. 9A, FIG. 9B, FIG. 10A and FIG. 10B, it turned out that the thicker the film thickness of the formed silver thin film, the larger the grain size of the formed silver nanoparticles becomes.

(Formation of Titanium Oxide Film)

A titanium oxide film was further formed by a sol gel method under the following conditions on the amorphous silica film obtained as described above on each of the substrates to obtain the photocatalyst structure.

—Formation Conditions of Titanium Oxide Film by Sol Gel Method—

A sol-gel solution “Bistrator H NDH510-C” (a product of Nippon Soda Co., Ltd.) or its dilution with ethyl acetate by up to 10 times was spin-coated to obtain a desired film thickness. After drying it at 120° C., baking was performed at 500° C. for 30 minutes.

Similarly with the fabrication of the above-mentioned photocatalyst structure except that the film thickness of the silver thin film is set to 10.0 mm, another photocatalyst structure was fabricated and the resulting photocatalyst structure was observed with a scanning electron microscope (SEM).

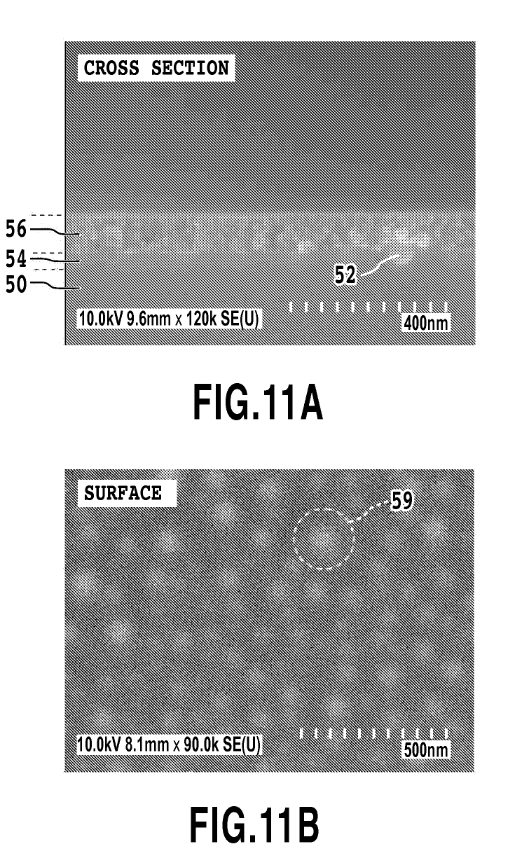

FIG. 11A is an SEM image showing a cross section of the photocatalyst structure; FIG. 11B is an SEM image showing the titanium oxide film surface of the photocatalyst structure.

From FIG. 11A, silver nanoparticles 52 with a particle size of approximately 60 nm can be identified in an amorphous silica film 54 (film thickness of 40 nm) and a titanium oxide film 56 (film thickness of 90 nm). Incidentally, in FIG. 11A, since an interface of the amorphous silica substrate 50 and the amorphous silica film 54 is an interface of homogeneous materials, it cannot be identified clearly.

Also, a cloud-like white area in FIG. 11B (for example, an area 58) is considered to be a silver nanoparticle covered with the titanium oxide film and the amorphous silica film.

Next, for the above-mentioned photocatalyst structure obtained under the condition of the film thickness of the silver thin film being 10.0 nm, the film thickness of the amorphous silica film was changed from 40 nm to 20 nm. The amorphous silica film was not able to cover the silver particle and silver precipitated on the titanium oxide film surface.

### Second Example

### Optical Absorption Spectral Measurement of Photocatalyst Structure

Silver nanoparticles with particle size of 70 nm were formed on a substrate by forming a silver thin film with film thickness of 10.0 nm by vacuum deposition and heat-treating the film at 800° C. for 5 minutes.

A photocatalyst sample 1 was fabricated by forming an amorphous silica film with film thickness of 25 nm on the side on which silver nanoparticles were formed of the substrate by sputtering technique, and depositing titanium oxide with film thickness of 170 nm on the formed amorphous silica film by sol gel method.

Conditions other than the above-mentioned ones are the same as the conditions of the first example.

The structure of the photocatalyst sample 1 is a structure where silver nanoparticles coated with amorphous silica are contained in a titanium oxide film (hereinafter also denoted by “TiO₂/SiO₂/Ag”).

Next, similarly with the fabrication of the above-mentioned photocatalyst sample 1 except that an amorphous silica film was not formed, a comparison sample 1 was fabricated. The structure of the comparison sample 1 is a structure where silver nanoparticles uncoated with amorphous silica are contained in a titanium oxide film (hereinafter also denoted as “TiO₂/Ag”).

A comparison sample 2 was fabricated by the same method as the fabrication of the above-mentioned photocatalyst sample 1 except that silver nanoparticles and also an amorphous silica film were not formed. The structure of the comparison sample 2 is a structure where silver nanoparticles are not contained in the titanium oxide film (hereinafter also denoted as “TiO₂”).

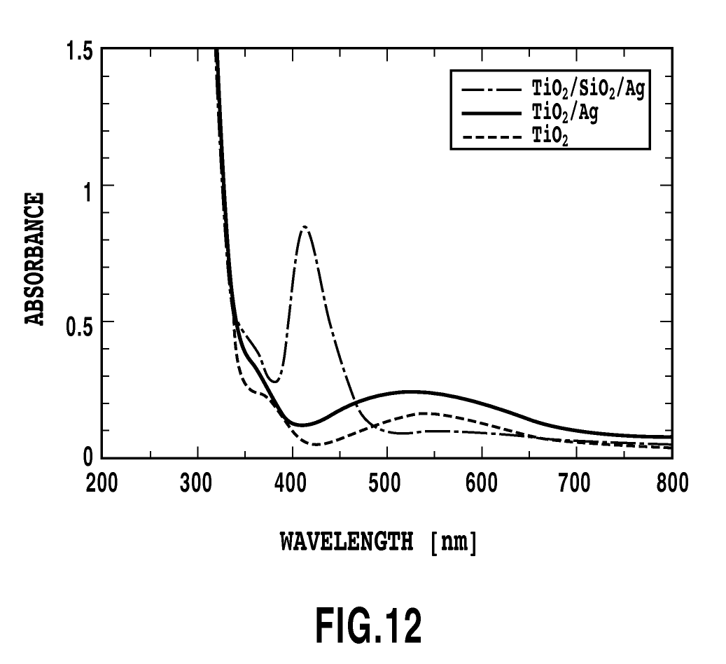

The optical absorption spectrum was measured using the Lambda 900, a product of PerkinElmer, Inc., for each of the photocatalyst sample 1, the comparison sample 1, and the comparison sample 2 obtained as above. FIG. 12 shows results of the measurements.

As can be seen from the graphs of FIG. 12, an absorption peak by a localized surface plasmon light was observed in the vicinity of wavelength 420 nm for the photocatalyst sample 1 (“TiO₂/SiO₂/Ag”). On the other hand, an absorption peak by a localized surface plasmon light was not observed in the comparison sample 1 (“TiO₂/Ag”) and the comparison sample 2 (“TiO₂”).

The reason for the observation of an absorption peak by a localized surface plasmon light only in the photocatalyst sample 1 is thought to be that coating the silver nanoparticles with amorphous silica eliminates contact between titanium oxide and silver, thereby preventing the oxidation of silver.

### Third Example

### Evaluation of Catalyst Efficiency

The catalyst efficiency was evaluated by measuring a removal efficiency of methylene blue.

### (Manufacture of Measurement Sample)

A silver thin film with film thickness of 10.0 nm was formed on a substrate by vacuum deposition, and was heat-treated at 800° C. for 5 minutes to form silver nanoparticles. Next, an amorphous silica film with film thickness of 40 nm was formed by sputtering technique on the side of the substrate on which the silver nanoparticles were formed, and titanium oxide with film thickness of 90 nm was deposited on the formed amorphous silica film by sol gel method to fabricate a photocatalyst sample 11 (“TiO₂/SiO₂/Ag”).

Conditions other than the above-mentioned ones are the same as the fabrication conditions of the photocatalyst sample 1 of the second example.

Next, a comparison sample 11 (“TiO₂”) was fabricated in the same manner as in the above-mentioned photocatalyst sample 11 (“TiO₂/SiO₂/Ag”) except that silver nanoparticles and an amorphous silica film were not formed.

(Measurement of Removal Efficiency of Methylene Blue)

Methylene blue was made to be adsorbed on the surface of the titanium oxide film of the photocatalyst sample 11 (“TiO₂/SiO₂/Ag”) so that the absorbance at wavelength 580 nm becomes about 0.17, and then black light was irradiated on the surface (the titanium oxide film surface) of the photocatalyst sample 11. A black light irradiation time was changed in a range from 0 to 4.0 minutes with a step of 0.5 minute. The irradiation was stopped after a lapse of each irradiation time, and the absorbance I of methylene blue at wavelength 580 nm was measured by optical absorption spectrum. Incidentally, since methylene blue looks discolored immediately after the black light irradiation (immediately after the irradiation is stopped after the lapse of each irradiation time), the above-mentioned measurement was performed after relaxing methylene blue that is in an excitation state in a dark place.

Next, for each of the above-mentioned irradiation times, a rate of change in the absorbance (Iₜ−I₀/I₀) was found, and the reduction rate of an amount of adsorption of methylene blue was estimated. Here, I₀ designates the absorbance I for the irradiation time 0 minute (namely, no irradiation), and Iₜ designates the absorbance I after the lapse of the irradiation time t.

It is indicated that the larger the ratio of change (Iₜ−I₀/I₀) in the absorbance I, i.e., the larger the reduction rate of the amount of adsorption of methylene blue, the more excellent the catalyst efficiency becomes.

Incidentally, the above-mentioned measurements were performed at three different points in the sample (measurement points 1 to 3), respectively.

Detailed conditions for each of the above-mentioned operations are as follows.

### —Adsorption of Methylene Blue—

As methylene blue, methylene blue trihydrate, a product of Wako Pure Chemical Industries, Ltd., was used.

### —Black Light Irradiation—

For the black light, a black light blue fluorescent lamp the FL10BL-B, 10 W, a National product, was used. The luminance distribution of this lamp has a peak at wavelength 360 nm.

Next, the comparison sample 11 (“TiO₂”) was subjected to the same evaluation as that of the photocatalyst sample 11 (“TiO₂/SiO₂/Ag”).

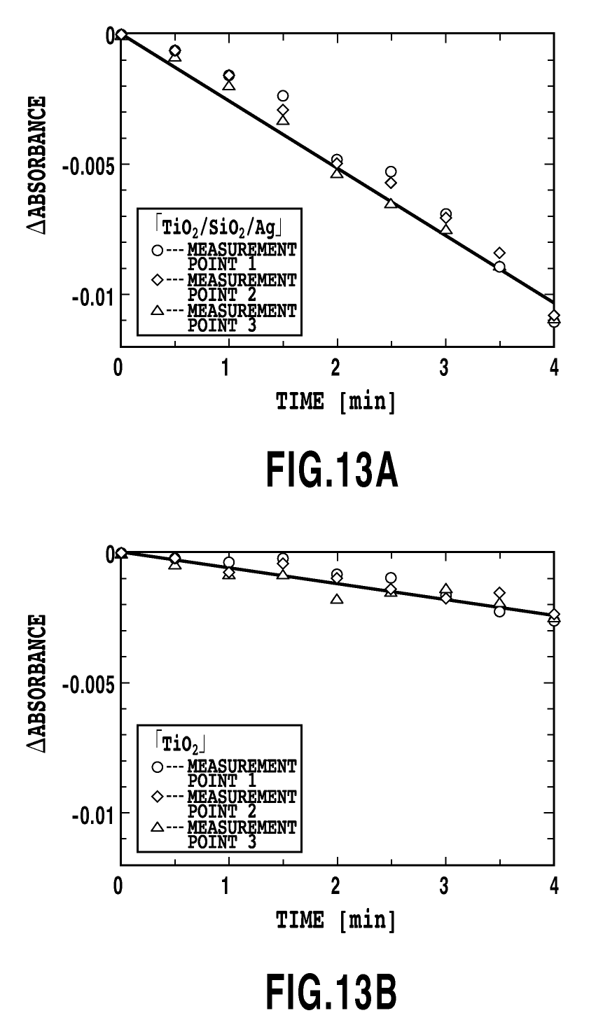

FIG. 13A shows measurement results of the photocatalyst sample 11 (“TiO₂/SiO₂/Ag”); FIG. 13B shows measurement results of the comparison sample 11 (“TiO2”).

In graphs of FIGS. 13A, 13B, the horizontal axis represents black light irradiation time, and the vertical axis represents the rate of change [(Iₜ−I₀)/I₀] of absorbance I (in FIGS. 13A, 13B, it is denoted by “ΔAbsorbance”). The figure shows that the larger the absolute value of the gradient of a graph, the more excellent the removal efficiency (decomposition efficiency) of methylene blue becomes, and the more excellent the catalyst efficiency becomes.

The gradient of the graph of FIG. 13A was found to be −2.489×1.0⁻³ [1/min] by a method of least squares, and the gradient of the graph of FIG. 13B was found to be −5.556×10⁻⁴ [1/min] by the method of least squares.

Comparison of the gradient of the graph of FIG. 13A with the gradient of the graph of FIG. 13B indicates that the photocatalyst sample 11 (“TiO₂/SiO₂/Ag”) has the removal efficiency of methylene blue about 4.5 times larger than the comparison sample 11 (“TiO₂”).

That is, it turned out that the former is excellent in catalyst efficiency by about 4.5 times as compared with the latter.

### Fourth Example

### Dependence of Localized Surface Plasmon Light on Amorphous Silica Film Thickness

Next, a dependence of the localized surface plasmon light on the amorphous silica film thickness was investigated as in the following way.

### (Fabrication of Measurement Sample)

Under the same conditions as conditions of the vacuum deposition of the first example, a silver thin film of thickness of 7.0 nm was formed on a substrate by vacuum deposition, and the substrate with the silver thin film was heat treated at 800° C. for five minutes to form silver nanoparticles. The particle size of the formed silver nanoparticles was approximately 50 nm.

A photocatalyst sample of “TiO₂/SiO₂/Ag” structure was fabricated by forming an amorphous silica film with film thickness of 8 nm on the side of the substrate on which silver nanoparticles were formed under a condition of sputtering electric power 50 W, and depositing a titanium oxide film with film thickness of 70 nm on the formed amorphous silica film by sol gel method.

Conditions other than the above-mentioned ones are the same as the fabrication conditions of the photocatalyst sample 1 of the second example.

Next, photocatalyst samples of the “TiO₂/SiO₂/Ag” structure were respectively fabricated in the same way as the above except that the film thicknesses were respectively changed to 12 nm, 16 nm, and 30 nm by adjustment of the sputtering time in the formation of the amorphous silica film.

A comparison sample (silver nanoparticle itself) was fabricated in the same way as the above except that the amorphous silica film and the titanium oxide film were not formed.

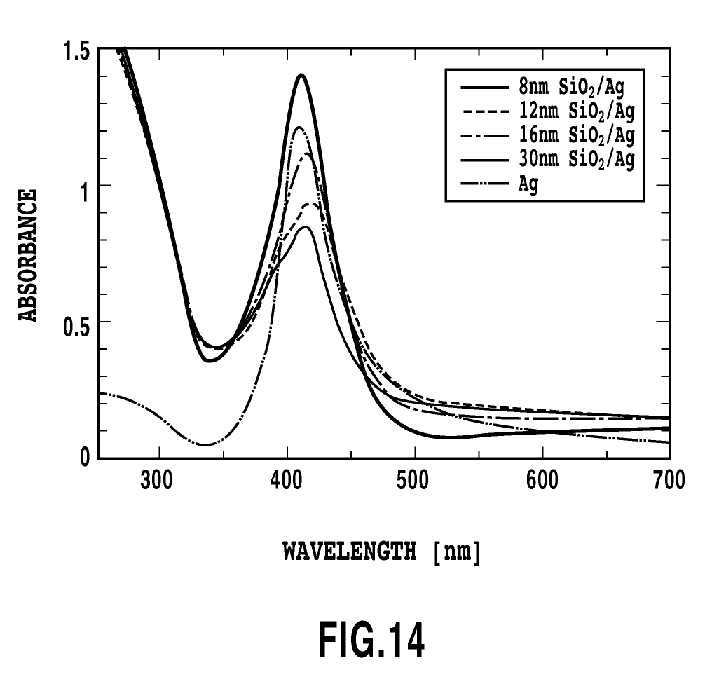

Optical absorption spectra were measured on the resulting photocatalyst sample and comparison samples using the Lambda 900, a product of PerkinElmer, Inc. FIG. 14 shows the results of the measurements. In FIG. 14, notations such as “8 nm SiO₂/Ag” etc. indicate that the sample is a photocatalyst sample (TiO₂/SiO₂/Ag” structure) whose amorphous silica film has a film thickness of 8 nm. Also, the notation “Ag” indicates a comparison sample (silver nanoparticle itself).

From FIG. 14, it can be seen that, in the cases where the film thicknesses of amorphous silica are 8 nm, 12 nm, and 16 nm, the absorption intensity of the localized surface plasmon light decreases when titanium oxide is deposited on amorphous silica compared to the case of silver nanoparticle itself. On the other hand, it was found that in the case where the film thickness of amorphous silica is 30 nm, the absorption intensity of the localized surface plasmon light does not decrease even when titanium oxide is deposited on amorphous silica and rather increases compared to the case of silver nanoparticles itself.

The above has revealed that thicker film thickness of amorphous silica more effectively prevents contact between silver and titanium oxide, improving the use efficiency of light and the catalyst efficiency.

### Fifth Example

### Dependence of Localized Surface Plasmon Light on Formation Conditions of Amorphous Silica Film

Next, dependence of the localized surface plasmon light on the formation conditions of the amorphous silica film was investigated in the following way.

### (Fabrication of Measurement Sample)

A silver thin film with film thickness of 10.0 nm was formed by vacuum deposition on a substrate under the same conditions as the conditions of the vacuum deposition of the first example, and the substrate with the silver thin film was heat treated at 800° C. for five minutes to form silver nanoparticles. The particle size of the formed silver nanoparticles was approximately 70 nm.

A photocatalyst sample of “TiO₂/SiO₂/Ag” structure was fabricated by forming an amorphous silica film with film thickness of 20 nm on the side of the substrate on which silver nanoparticles were formed under a condition of sputtering electric power 200 W, and depositing a titanium oxide film with film thickness of 70 nm on the formed amorphous silica film by sol gel method.

Conditions other than the above-mentioned ones are the same as the fabrication conditions of the photocatalyst sample 1 of the second example.

Photocatalyst samples of “TiO₂/SiO₂/Ag” structure were respectively fabricated in the same way as the above except that the sputtering electric power was changed to 50 W and also that the film thicknesses were respectively changed to 16 nm, 20 nm, 24 nm, and 30 nm by adjustment of the sputtering time in the formation of the amorphous silica film in the fabrication of the above-mentioned photocatalyst samples.

A comparison sample of “SiO₂/Ag” structure was fabricated in the same way as the above except that the titanium oxide film was not formed and that amorphous silica was formed under conditions of sputtering electric power 50 W and film thickness of 30 nm.

Optical absorption spectrum measurements were performed on the resulting photocatalyst sample and comparison samples using the Lambda 900, a product of PerkinElmer, Inc.

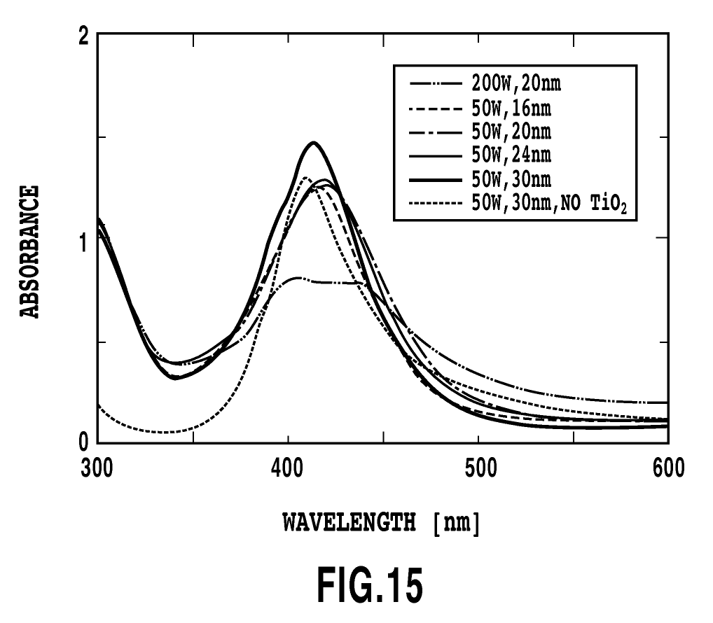

FIG. 15 shows measurement results. In FIG. 15, a notation such as “200 W, 20 nm” indicates the photocatalyst sample where the amorphous silica film with film thickness of 20 nm was formed under a condition of sputtering electric power 200 W. Additionally, the comparison sample is indicated as “50 W, 30 nm, and no TiO₂.”

From FIG. 15, it can be seen that in the case of sputtering electric power of 200 W, the rate of absorption of the localized surface plasmon light becomes small, whereas in the case of sputtering electric power of 50 W, the rate of absorption of the localized surface plasmon light becomes large. This result means that the amorphous silica film deposited with sputtering electric power of 50 W functions better as a partition wall. A reason for this is thought to be that when amorphous silica is deposited with low electric power, it becomes a denser film, which can more effectively prevent oxidation of the silver nanoparticles.

Moreover, it turned out that as the film thickness of amorphous silica increases to 16 nm, 20 nm, 24 nm, and 30 nm, the absorption intensity of the localized surface plasmon light increases. Thus, it has been found that thicker film thickness of amorphous silica more effectively prevents the contact between silver and titanium oxide, improving the use efficiency of light and the catalyst efficiency as in fourth example.

### INDUSTRIAL APPLICABILITY

The photocatalyst structure of the present invention can improve the catalyst efficiency of the photocatalyst dramatically and stably. Therefore, the photocatalyst structure of the present invention is applicable to various industrial fields, such as housing-related, water treatment and soil-related, air treatment-related, medical care-related, electronic parts-related, electric appliance-related, vehicle-related, road-related, and agriculture-related fields.

1. A photocatalyst structure, comprising:
a metal nanoparticle;
a semiconductor photocatalyst; and
a material transparent to a light of a wavelength which excites the semiconductor photocatalyst, the material intervening between the metal nanoparticle and the semiconductor photocatalyst.

2. The photocatalyst structure according to claim 1, wherein the metal nanoparticle does not exist on a reaction surface of the semiconductor photocatalyst.

3. The photocatalyst structure according to claim 1 or 2, wherein the semiconductor photocatalyst is a thin film formed on a base material.

4. The photocatalyst structure according to claim 1 or 2, wherein the material transparent to a light of a wavelength which excites the semiconductor photocatalyst is a thin film formed on the base material so as to cover at least a part of the metal nanoparticle, and wherein the semiconductor photocatalyst is a thin film formed on the thin film comprised of the transparent material.

5. The photocatalyst structure according to claim 1 or 2, wherein the metal nanoparticle contains silver.

6. The photocatalyst structure according to claim 1 or 2, wherein the semiconductor photocatalyst contains titanium oxide.

7. The photocatalyst structure according to claim 1 or 2, wherein the material transparent to a light of a wavelength which excites the semiconductor photocatalyst contains silicon oxide.
